(19) United States
(12) Patent Application Publication
(10) Pub. No.: US 2022/0126944 A1
(43) Pub. Date: Apr. 28, 2022

(54) STEERING FOOT PEG FOR MOTORCYCLE

(71) Applicant: David Ramsar Williams, II, Culver City, CA (US)

(72) Inventor: David Ramsar Williams, II, Culver City, CA (US)

(21) Appl. No.: 17/510,294

(22) Filed: Oct. 25, 2021

Related U.S. Application Data
(60) Provisional application No. 63/104,605, filed on Oct. 23, 2020.

(51) Int. Cl. B62J 25/00

(52) U.S. Cl. CPC B62J 25/00

(57) ABSTRACT

A steering and stabilization foot peg system and apparatus for use on motorcycles to facilitate the execution of at-speed turning of a motorcycle by a rider without the use of his or her hands is described. The foot pegs are configured to be installed to the forks of the motorcycle, adjacent to front turning signals. The foot pegs effectively mirror the functionality of the handlebars of the motorcycle, and enable the user to employ conventional counter-steering techniques to manipulate the direction heading of the motorcycle without the need to touch the handlebars. Specialized mounts equipped with mounting hardware are configured to ensure that the foot pegs remain in a fixed position on the forks, eliminating the chance that the foot pegs could rotate or move up or down on the forks without manual adjustment.

### CONTINUITY

This application is a non-provisional patent application of provisional patent application No. 63/104,605, filed on Oct. 23, 2020, and priority is claimed thereto.

### FIELD OF THE PRESENT INVENTION

The present invention relates to the field of motorcycle accessories, and more specifically relates to a system and apparatus configured to be installed to the forks of a motorcycle to facilitate the execution of turns and bike stabilization with the feet of the rider.

### BACKGROUND OF THE PRESENT INVENTION

Motorcycle riding continues to be a loved pastime around the world, and particularly in America. Motorcycle rallies, rides, fundraisers, and other events help to fuel the national phenomenon. In other parts of the world, riding is a necessity, and facilitates a fuel-efficient means by which the rider (and minimal goods/service) may be transported easily.

On long stretches of highway, it is known that the riding position required by some motorcycles can cause fatigue of the rider. An assortment of products are presently available on the market to help to reduce this fatigue, including, but not limited to cruise control mechanisms (electronic or manual via a throttle lock), highway pegs, back rests, padded seats, etc. While cruise control mechanisms enable the rider to set and maintain a specific speed, the user must still employ at least one hand to stabilize the motorcycle, as well as to execute minor turns in the road while under power. Even with padded handlebars and gloves, the vibrations effected by the motor of the motorcycle can cause hand fatigue. Similarly, holding one's hand up and on the handlebar for extended periods of time can be exhausting, especially to riders who are not accustomed to riding for long distances. If there were a way in which riders could employ their feet to stabilize the motorcycle at speed and facilitate the execution of turns in the road, users' hands would be less fatigued. Additionally, if such a solution could be integrated into a comfortable foot peg, highway pegs could be eliminated and replaced with more functional and equally comfortable steering pegs.

Thus, there is a need for a new apparatus and system configured to facilitate the use of a rider's feet to stabilize and execute minor turns. Such an apparatus preferably includes foot pegs coupled to a rigid mount which is configured to be disposed on forks of the motorcycle. Such placement enables the user to execute counter-balanced steering, as well as to effectively stabilize the motorcycle with both feet simultaneously, even over road bumps. Ideally, the foot pegs are equipped with a threaded rod, functioning as a secure screw to facilitate direct installation of the apparatus to pre-existing bolt holes on or near the fork assembly of the motorcycle.

### SUMMARY OF THE PRESENT INVENTION

The present invention is a steering peg system configured for installation on the forks of a motorcycle to facilitate the stabilization of the motorcycle without the use of hands. The system is similarly configured to enable the rider to execute minor turns without the need to place his or her hand(s) on the handlebars of the motorcycle. The system employs a mounting mechanism configured to prevent any rotation of the peg around the fork itself such that it remains perpendicular to the primary length axis of the motorcycle. Preferable mounting of the apparatus of the present invention includes use of the foot pegs as a direct bolt replacements for bolts conventionally found on the fork assembly of motorcycles from a variety of manufacturers. It is envisioned that different embodiments of the apparatus are equipped with differently sized threaded rods equipped with compatible dimensions and threading to facilitate installation on motorcycles from different manufacturers.

The following brief and detailed descriptions of the drawings are provided to explain possible embodiments of the present invention but are not provided to limit the scope of the present invention as expressed herein this summary section.

### BRIEF DESCRIPTION OF THE DRAWINGS

The accompanying drawings, which are incorporated herein and form a part of the specification, illustrate the present invention and, together with the description, further serve to explain the principles of the invention and to enable a person skilled in the pertinent art to make and use the invention.

The present invention will be better understood with reference to the appended drawing sheets, wherein:

FIG. 1 depicts a view of the apparatus of the present invention as seen from the side, isolated from a motorcycle.

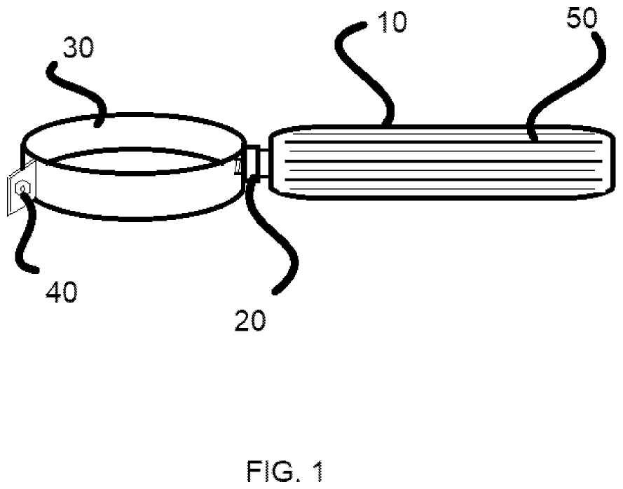

FIG. 2 exhibits a view of the apparatus of the present invention as seen from the front, shown installed on the forks of a motorcycle.

FIG. 3 shows a flow chart detailing the process of installation and use of the present invention by a user.

FIG. 4 exhibits a top side view of the bolt-replacement embodiment of the apparatus of the present invention, shown isolated from a motorcycle.

### DETAILED DESCRIPTION OF THE PREFERRED EMBODIMENT

The present specification discloses one or more embodiments that incorporate the features of the invention. The disclosed embodiment(s) merely exemplify the invention. The scope of the invention is not limited to the disclosed embodiment(s).

References in the specification to “one embodiment,” “an embodiment,” “an example embodiment,” etc., indicate that the embodiment described may include a particular feature, structure, or characteristic, but every embodiment may not necessarily include the particular feature, structure or characteristic. Moreover, such phrases are not necessarily referring to the same embodiment, Further, when a particular feature, structure, or characteristic is described in connection with an embodiment, it is submitted that it is within the knowledge of one skilled in the art to effect such feature, structure, or characteristic in connection with other embodiments whether or not explicitly described.

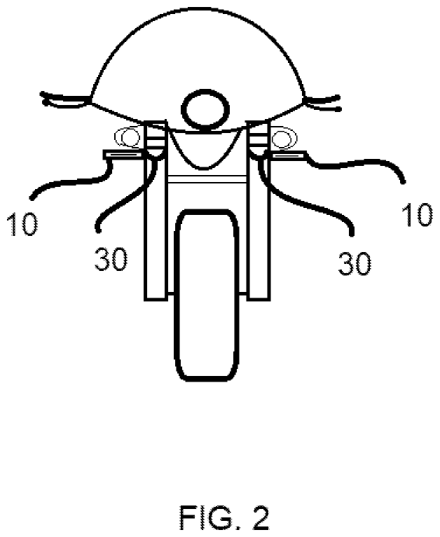

The present invention is a motorcycle accessory configured to facilitate the stabilization of the motorcycle, as well as the execution of minor turns, by the rider without the use of hands. The present invention is equipped with a foot peg (10), connection point (20), and mount (30). The mount (30) is preferably reinforced and is composed of a metallic alloy. The mount (30) is configured to prevent any movement of the foot peg (10) and mount (30) in any direction while installed, and is therefore rigidly mounted to the fork cylinder of the motorcycle, or the fork fascia of the motorcycle as shown in FIG. 2. Bolts (40) are preferably employed to ensure that the mount (30) remains tight and in position on the forks of the motorcycle. The foot pegs (10) of the present invention are configured with a wider surface than that of conventional highway pegs, and are also longer such that they protrude out and away from the forks and frame of the motorcycle.

The foot pegs (10) of the present invention are preferably equipped with gripping (50) which may be engraved, embossed, or present in the form of a rubberized strips or coating to help grip the shoe or boot of the rider to the foot pegs (10) securely. It is envisioned that the gripping (50) may be present in a wide variety of shapes, patterns, and textures to provide for variation in the designs of the present invention. It is envisioned that the foot pegs (10) are approximately five inches in length and at least an inch in diameter. The foot pegs (10) need not be cylindrical, and instead may be formed as a slat which is angled towards the rider for comfort, as well as the maximize the efficacy of the foot pegs (10) in mirroring the effect of handlebar use for cycle stabilization and turning. It is further envisioned that in a majority of installations, the present invention is ideally mounted underneath the front turning signals of the cycle, on the upper portion of the forks.

Additionally, it should be noted that the mount (30) of the present invention may be available in differing types in order to accommodate differing chassis styles, fork heights/lengths, and other conventional differentiating features of conventional motorcycles. As such, a variety of clamps, screws, bolts, and similar conventional mounting mechanisms may be employed as required by the style and orientation of the motorcycle to which the present invention is installed. The preferred embodiment of the present invention currently employs a female 5/16-18 inch gauge mounting; however it should be understood that additional sizing and fittings of the mount (30) of the present invention may vary in accordance with the fork diameter, body style, and other parameters of the motorcycle to which the present invention is installed. As such, the thread pattern may also differ according to existing attachment points if needed.

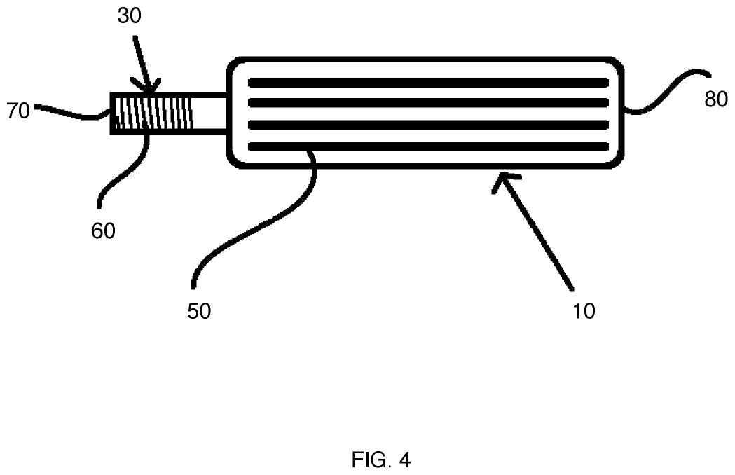

An example of the bolt replacement embodiment of the present invention is depicted in FIG. 4, embodied in a threaded rod (male) extending from the foot peg (10), the threaded rod functioning as the mount (30) in such embodiments. Threads (60) are present along the mount (30) in such embodiments as depicted in FIG. 4. The threads (60) are disposed on a shaft of the mount (30) disposed on a second end (70) disposed opposite of a first end (80) which functions as the foot peg (10). It should be noted that the first end (80), representing the portion of the foot peg (10) to which the foot of the user is placed, is preferably hollow to minimize added weight.

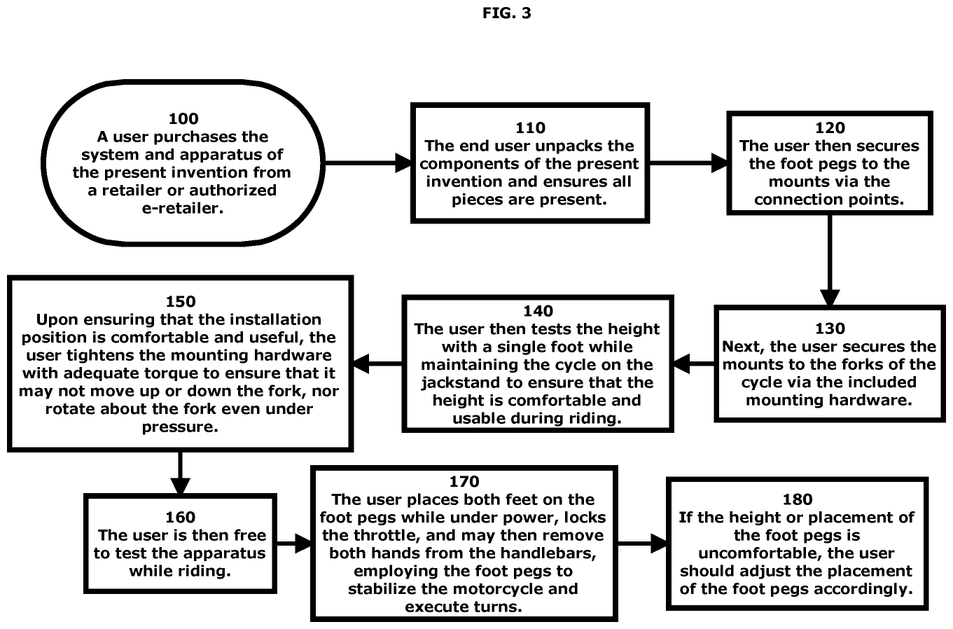

The process of installation and use of the system and apparatus of the present invention, as shown in FIG. 3, is preferably as follows:
1. A user purchases the system and apparatus of the present invention from a retailer or authorized e-retailer. (100)
2. The end user unpacks the components of the present invention and ensures all pieces are present. (110)
3. The user then secures the foot pegs to the mounts via the connection points. (120) The pegs may be screwed into female sockets of the connection points, or may be affixed via nuts and bolts under an adequate amount of torque to ensure that the pegs may not be removed or rotated during use.
4. Next, the user secures the mounts to the forks of the cycle via the included mounting hardware. (130)
5. The user then tests the height with a single foot while maintaining the cycle on the jack stand to ensure that the height is comfortable and usable during riding. (140)
6. Upon ensuring that the installation position is comfortable and useful, the user tightens the mounting hardware with adequate torque to ensure that it may not move up or down the fork, nor rotate about the fork even under pressure. (150)
7. The user is then free to test the apparatus while riding. (160)
8. The user places both feet on the foot pegs while under power, locks the throttle, and may then remove both hands from the handlebars, employing the foot pegs to stabilize the motorcycle and execute turns. (170)
9. If the height or placement of the foot pegs is uncomfortable, the user should adjust the placement of the foot pegs accordingly. (180)

It should be noted that the foot peg (10) and mount (30) of the present invention are preferably composed of metallic alloys, including, but not limited to steel, zinc, and/or aluminum. Further, it should be understood that the mounts (30) of the present invention, in some embodiments, facilitate the adjustment of the height of the foot pegs (10) along the left and right forks of the motorcycle as desired for comfort. Both the right foot peg (10) and left foot peg (10) should be disposed at the same height for stability. In some embodiments, the mount (30) is configured to be affixed under the turn signal brackets of the motorcycle. In other embodiments, as previously disclosed, the mount (30) is effectively a replacement bolt for a pre-existing hole on the motorcycle. In such embodiments, the diameter and thread spacing of the mount (30) is configured to match that of the bolt to which the apparatus replaces. As such, these embodiments are designed to be unique to each model and/or manufacturer of motorcycle.

Further, it should be noted that the apparatus of the present invention may be outfitted for use on bicycles, electric bicycles, or similar two wheeled vehicles equipped with a seat. In such installations, the foot pegs (10) facilitate manipulation of the direction of the vehicle via counter-steering pressure, just as they do in motorcycle installations, facilitating safe hands-free riding. The overall length of the apparatus may vary in accordance with the preference of the user, and in accordance with the presence and size of the shroud, turn signal bracket, and windshield placement of the motorcycle to which the apparatus is installed. In general, it is envisioned that the foot peg (10) portion of the present invention preferably extends between three to five inches out and away from the forks of the motorcycle.

Furthermore, it should be understood that the present invention exhibits foot pegs (10) having a first end (80) and a second end (70), the second end (70) equipped with threading (60) to function as a mount (30) in some embodiments. A textured grip (50) is present on the first end (80), facilitating placement of a foot on the foot peg (10). Exerting pressure by the rider via the feet on to the foot pegs (10) enables the user to counter-steer the motorcycle without the use of their hands. The foot peg (10) need not be cylindrical, and may exhibit a variety of other shapes.

Having illustrated the present invention, it should be understood that various adjustments and versions might be implemented without venturing away from the essence of the present invention. Further, it should be understood that the present invention is not solely limited to the invention as described in the embodiments above, but further comprises any and all embodiments within the scope of this application.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The exemplary embodiment was chosen and described in order to best explain the principles of the present invention and its practical application, to thereby enable others skilled in the art to best utilize the present invention and various embodiments with various modifications as are suited to the particular use contemplated.

I claim:

1. A motorcycle accessory for a motorcycle having a right side and a left side comprising:
a first shaft having a first end and a second end;
threading, said threading disposed on said second end of said shaft;
a textured grip, said textured grip disposed on said first end of said shaft;
a second shaft, said second shaft separate but identical to said first shaft;
wherein said threading of said second end of said first shaft and said second shaft matches a thread pattern of a bolt hole of the motorcycle;
wherein said first shaft is configured to be affixed to the right side of the motorcycle; and
wherein said second shaft is configured to be affixed to the left side of the motorcycle.

2. The motorcycle accessory of claim 1, wherein said first end of said first shaft is hollow.

3. The motorcycle accessory of claim 2, wherein said first end of said second shaft is hollow; and
wherein said second end of said first shaft and said second end of said second shaft are cylindrical.

4. A motorcycle accessory for a fork assembly of a motorcycle comprising:
a foot peg having a first end and a second end;
threading, said threading disposed on said second end;
a textured grip, said textured grip disposed on said first end;
a mount, said mount configured to interface with said second end; and
wherein said mount is affixed to the fork assembly of the motorcycle.

5. The motorcycle accessory of claim 4, wherein said first end is hollow.

6. The motorcycle accessory of claim 5, wherein said foot peg facilitates steering of the motorcycle when pressure is applied to said foot peg during riding.

7. The motorcycle accessory of claim 5, wherein said foot peg is rectangular.

8. The motorcycle accessory of claim 5, wherein said foot peg is cylindrical.

9. A method of manipulating the direction of a motorcycle with a right foot and a left foot of a rider comprising:
attaching a first mount to a right fork of the motorcycle;
attaching a second mount to a left fork of the motorcycle;
attaching a first foot peg to the first mount via at least one bolt;
attaching a second foot peg to the second mount via at least one bolt;
mounting the motorcycle and starting to ride;
placing the right foot on the first foot peg;
placing the left foot on the second foot peg;
pressing on the right foot peg with the right foot to execute counter-steering to the left; and
pressing on the left foot peg with the left foot to execute counter-steering to the right.

10. The method of claim 9, wherein said first mount is a first clamp; and
wherein said second mount is a second clamp.

11. The method of claim 9, wherein said first mount and said second mount are metal.

12. The method of claim 9, further comprising:
adjusting a height of the first mount on the right fork to a comfortable position in accordance with a height of the rider; and
adjusting a height of the second mount to be equal to the height of the first mount.

13. The method of claim 9, wherein the first foot peg and the second foot peg are between three and five inches in length.

14. The method of claim 9, wherein the first foot peg and the second foot peg are cylindrical.

15. The method of claim 9, wherein the first foot peg and the second foot peg are rectangular.
